(19) United States
(12) Patent Application Publication
(10) Pub. No.: US 2019/0195350 A1
(43) Pub. Date: Jun. 27, 2019

(54) ELECTRO-HYDRAULIC SYSTEM FOR THE ACTUATION OF MULTIPLE CLUTCHES AND GEAR SELECTORS WITH HIGH-PRECISION CONTROL OF SEVERAL SHIFT GEARBOX UNITS SIMULTANEOUSLY

(71) Applicant: LSP Innovative Automotive Systems GmbH, Unterföhring (DE)

(72) Inventors: Thomas LEIBER, Rogoznica (HR); Valentin UNTERFRAUNER, München (DE); Rainer WINZER, München (DE)

(21) Appl. No.: 16/331,357

(22) PCT Filed: Feb. 28, 2017
(86) PCT No.: PCT/EP2017/054642

§ 371 Date: Mar. 7, 2019

(30) Foreign Application Priority Data
Sep. 7, 2016 (DE) 10 2016 116 778.9
Sep. 29, 2016 (DE) 10 2016 118 423.3

(51) Int. Cl. F16H 61/02; F16H 61/00; F16H 61/12; F16H 57/04; F15B 11/20; F15B 21/14; F16D 25/10; F16D 25/12; F16D 48/06

(52) U.S. Cl. CPC F16H 61/0206; F16D 2500/70406; F16H 61/12; F16H 57/0473; F15B 11/20; F15B 21/14; F16D 25/10; F16D 25/123; F16D 48/062; F16H 2061/1208; F16H 2061/1264; F15B 2211/20515; F15B 2211/20538; F15B 2211/275; F15B 2211/6336; F15B 2211/88; F16D 2500/1045; F16D 2500/3026; F16H 61/0031

(57) ABSTRACT

A shift gearbox, a control unit and at least one electric-motor-driven piston-cylinder unit which has a piston and is connected via hydraulic lines to multiple shift gearbox units of the shift gearbox and shifts them, the shift gearbox units comprising at least two clutch units, characterised in that the piston of the piston-cylinder unit is in the form of a dual-action reciprocating piston, wherein the dual-action reciprocating piston sealingly separates two working chambers from each other, wherein each working chamber is connected via a main hydraulic line to one clutch each, and at least one working chamber of the dual-action reciprocating piston can be connected hydraulically via a switch valve to the reservoir.

The invention relates to a shift gearbox, a control unit and at least one electric-motor-driven piston-cylinder unit which has a piston and is connected via hydraulic lines to multiple shift gearbox units of the shift gearbox and shifts them, the shift gearbox units comprising at least two clutch units.

### PRIOR ART

DE 10 2006 038 446 A1 describes a shift gearbox having an electric-motor-driven piston-cylinder unit, in which one or two piston-cylinder units operate four gear selectors and two clutches. The piston-cylinder unit generates the pressure necessary for shifting the gear selectors and clutches, wherein a pressure sensor measures the pressure generated. DE 10 2006 038 446 A1 describes two possible embodiments for this. In the first embodiment clutches and gear selectors are shifted for actuation of what are known as multiplex valves by means of the piston-cylinder unit. Here, the pressure build-up and the pressure reduction can take place by means of the piston-cylinder unit. But it is also possible for additional exhaust valves to be provided for certain, or all, consumers, via which the pressure in the individual consumers can be lowered in a controlled manner.

### OBJECT OF THE INVENTION

The object of the invention is to further improve the shift gearbox known from DE 10 2006 038 446 A1.

This object is achieved according to the invention by a shift gearbox in which the piston of the piston-cylinder unit is in the form of a dual-action reciprocating piston, wherein the dual-action reciprocating piston sealingly separates two working chambers from each other, and each working chamber is connected via a main hydraulic line to one clutch each, and at least one working chamber of the dual-action reciprocating piston can be connected hydraulically via a switch valve to the reservoir.

Advantageous configurations of this shift gearbox are indicated by the features of the subclaims.

By using a dual-action reciprocating piston, which via its two working chambers in both stroke directions of the dual-action reciprocating piston is able to deliver hydraulic medium to or from one of the shift gearbox units, inter alia, advantageously a short construction of the piston-cylinder unit can be achieved. Thus, both piston surfaces can have the same area, so that during the pre-stroke and the return stroke the same volume is delivered for the same travel of the piston. But it is also possible for the piston surface areas to be of different sizes, e.g. in a ratio of 1.5-2:1, so that during the pre-stroke between 1.5 and 2 times the volume is delivered compared to the return stroke, so that in the pre-stroke volume can be delivered more quickly for the purpose of a faster pressure build-up and thus a quicker operation of the clutch or a quicker gear operation. In this way, very short switching times of a dual-clutch gearbox can be achieved, in particular if at the same time in another clutch the pressure is reduced via a solenoid valve in the reservoir and optimum use can be made of the speed-torque characteristic of an electric motor at a given supplier voltage.

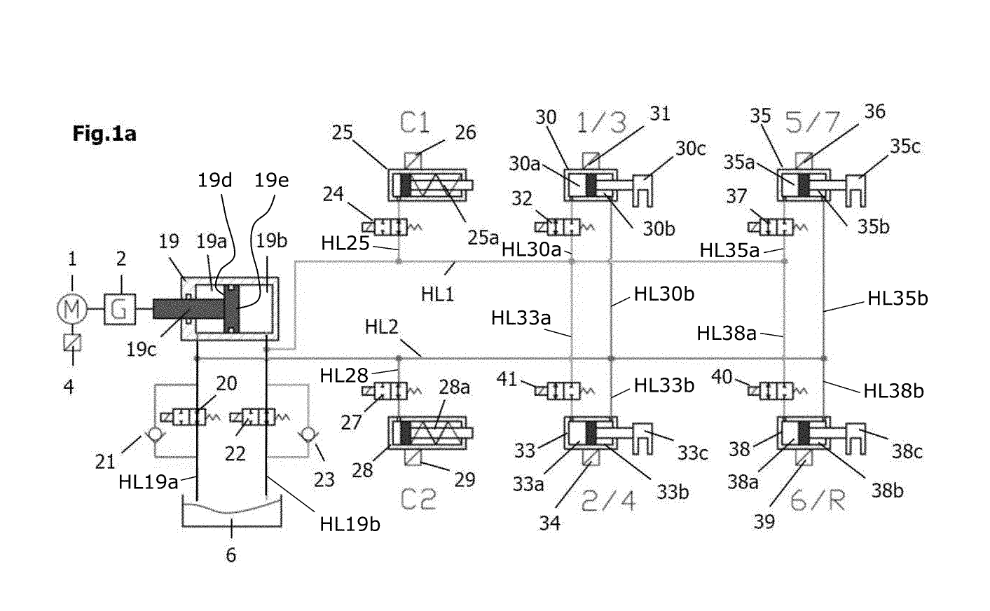

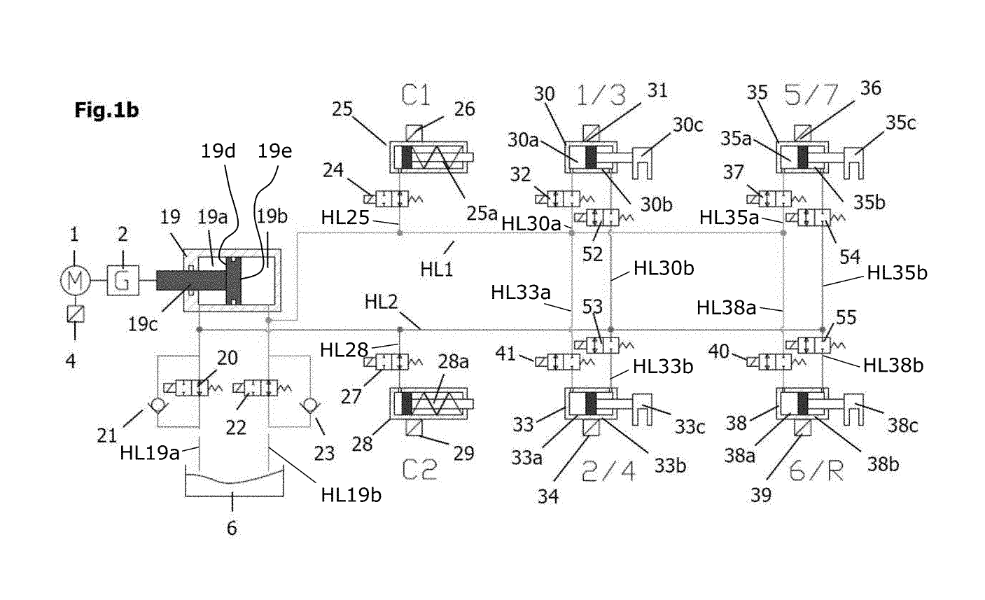

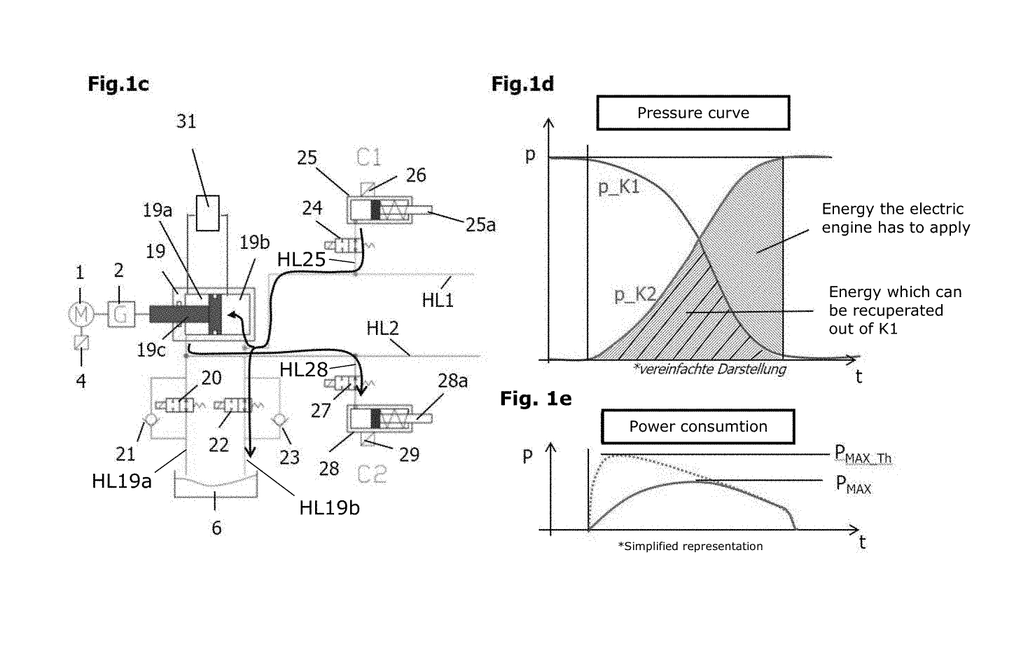

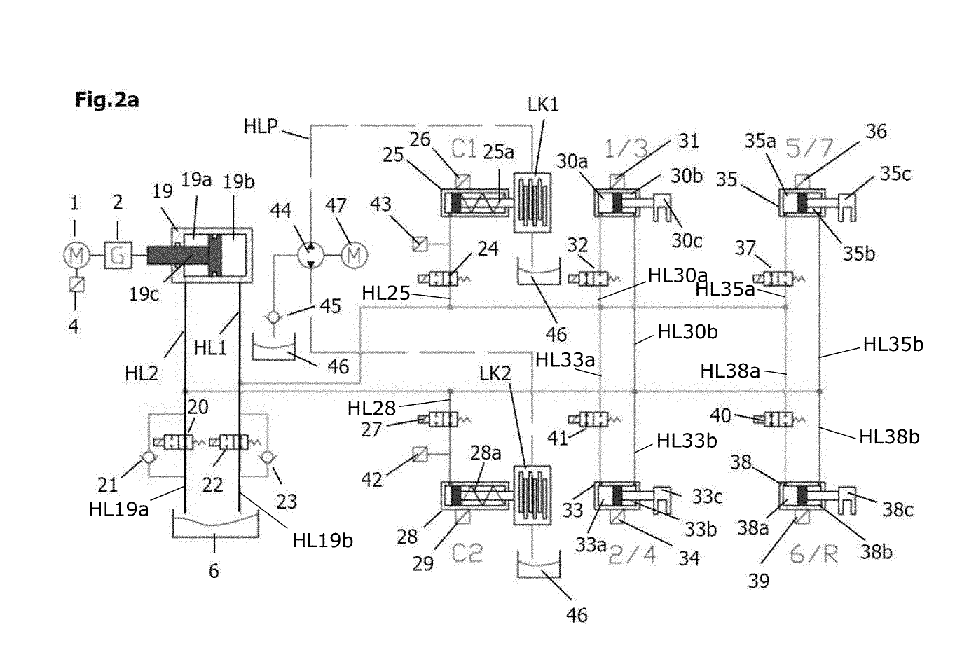

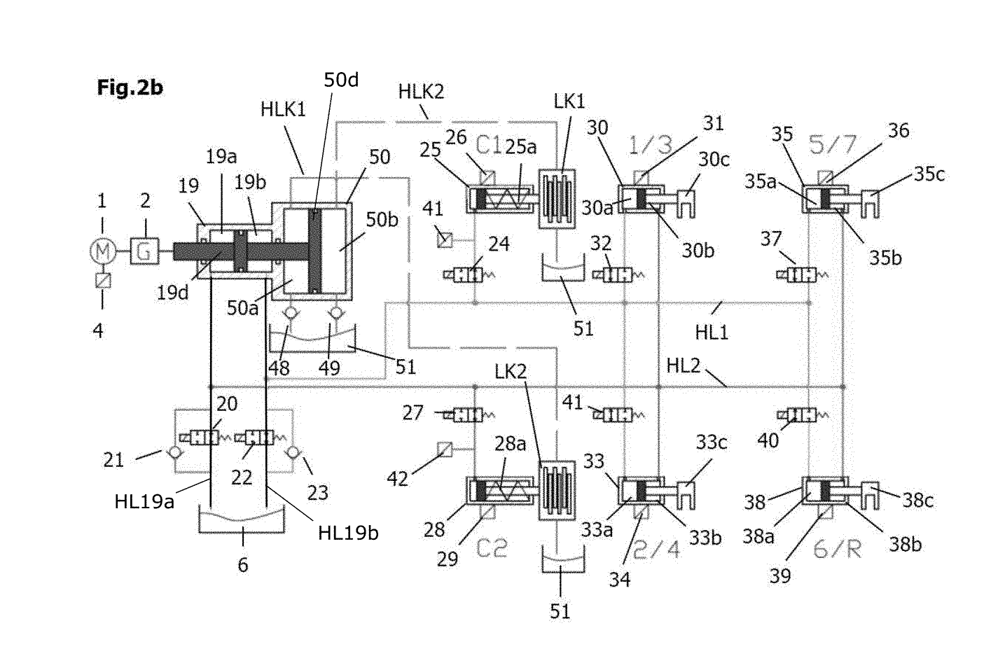

These different areas/two pressure chambers of the dual-action reciprocating piston can also be used for control as follows:
a) In gear selectors with 2 different areas, allowing volume control by a valve between gear selector and pressure supply unit (FIG. 1).
b) Use of 2 areas of the pressure supply unit and gear selector (FIG. 2).
c) Use for downsizing of the electric motor, power determined primarily at the time of clutch operation (pressure build-up with clutch with smaller working area). Use of small area during clutch operation, or changeover via 2 areas of the dual-action reciprocating piston by switch valve (->see extension in figures by a further switch valve).
d) Recuperation during dual-clutch operation or use of the stored hydraulic energy in a clutch during the process of switching between two clutches for downsizing of the electric motor (use of travel control and exhaust valve to reservoir) (FIG. 1c).

The volume ratio of 2:1 can also be expediently used, in that via a switch a volume compensation between the two working chambers of a dual-action reciprocating piston can be achieved and thus the axial force loading on the transmission is reduced, since in the pre-stroke and in the return stroke only half the area impinges on the transmission unit. This is particularly expedient at high pressures, since the axial force reduces the transmission loading thereby allowing an inexpensive plastic trapezoidal spindle drive to be used. The advantage of the dual-action reciprocating piston over a continuously operating pump is that the pressure generation unit only has to be operated during a shifting operation.

Controlling the travel of the piston, which amounts to volume control, results in a less expensive construction, in which the number of valves used can be advantageously reduced. Due to the travel or volume control, in a simple manner, without expensive pressure control, at least one shift gearbox unit can have more than two gearshift positions, since because of the incompressibility of the hydraulic medium via a predetermined volume delivered the respective shift gearbox unit can be purposefully shifted into one of the possible positions. Through the travel or volume control by pistons, the components of the shift gearbox units, in particular gear and clutch selectors can also be shifted accurately and more quickly than with proportional valves, since on the basis of prior knowledge of the displacement volume an additional control variable can be applied.

However, proportional valves can only make limited use of this advantage, since their control variable relates to valve flow and this in turn is dependent upon the hydraulic fluid condition and its viscosity. Furthermore, by virtue of the known volume management and the leak-free design there are few external leakages from the reservoir itself and valve leakages can be accurately diagnosed.

By using at least one pressure sensor or one position detector, for some shift gearbox units a pressure control or position control for the pressure build-up and also alternatively for the pressure reduction can advantageously be provided, so that by means of the piston-cylinder unit both travel or volume control and also pressure regulation takes place.

The pressure control takes place through specific piston travel control or specific energisation of the electric motor. During pressure control, the non-linear relationship between pressure and piston travel is captured and stored in a map. This map is used during pressure control such that a particular travel is performed via the piston, corresponding to a particular pressure. If the map changes as a result of temperature or air inclusions, it is recalibrated or captured again. This can be done in various ways (compensation via pressure sensor, compensation via travel control and using the electric motor current).

Alternatively, via the current of the electric motor, a torque can be controlled. For an accurate torque determination, by way of example the torque constant kt (relationship between the torque of the electric motor and the phase current) of the electric motor can be used. The torque constant can be determined for electric motors during production or commissioning and is characterised in that kt changes minimally over time and essentially changes only linearly under the influence of temperature. Alternatively to the phase current, the supplier current of the electric motor can be used.

In the event that no pressure sensor is available, a pressure estimation can be achieved by modelling. According to the invention, then, a model can comprise a motor and gearbox which, for example, pushes or possibly pulls on a single-acting or double-acting hydraulic piston. For a sufficiently good pressure estimation for a transmission unit, the parameters in the subunits (motor torque constant kt, transmission efficiency and hydraulic piston cross-sectional area, friction from seals) must either be subjected to low influences or adapted at regular intervals of time to the fluctuations in the parameters.

An accurate model can be created in that the abovementioned parameter changes of the model which adversely affect the pressure estimation or pressure control are captured during operation. For example, pressure sensors can be used which are only active in partial operation or an indirect pressure calculation applied.

In a method for indirect measurements of the pressure via the current of the electric motor, a calculation can be performed via the position of the clutch piston in the slave cylinder and the effective cross-sectional area of the piston of the master cylinder, with the help of knowledge about the spring of the clutch pressure plate and the diameter of the clutch slave cylinder. In this way a system can completely dispense with a pressure sensor, leading to significant cost savings, since pressure sensors are the main cost drivers in hydraulic systems. In mass production applications, a pressure sensor is approximately 4 times as expensive as a switch valve and equally expensive as a proportional valve.

If the system architecture is now one of a transmission actuator, operated with a motor with hydraulic pistons, this does not necessarily have to be provided with a pressure sensor. Differing pressures in the system can, as described above, be adequately estimated by modelling. In particular, the information on pressure for a shift position can be advantageous. If a gear selector is operated, the force on its shifter fork can be calculated. This means that the position in the gear selector where the synchronisation starts is known and so there is no need for separate algorithms which teach the synchronisation points in all gear selectors. Previously-known systems, such as for example the transmission actuator described in DE 101 34 115 B4, do not have pressure sensors, only position sensors in the gear selectors. The synchronisation point is then evaluated if the speed in the gear train or in the sub-gear train changes. Due to the high mass inertia of the gear trains the speed changes significantly more slowly than the pressure in the gear selector and must therefore, to keep the dynamics high, rely on empirical values from earlier shiftings or learning processes.

Wet clutches can also be advantageously used, wherein the fluid for cooling the wet clutches can be used either by means of the drives for the dual-action reciprocating piston or separate drives. Thus, for example, an additional dual-action reciprocating piston can be coupled with or rigidly connected to the first dual-action reciprocating piston, which is used to displace the coolant. When the first dual-action reciprocating piston is shifted, then the coolant is also simultaneously delivered. If no clutch or gear selector has to be shifted, the first dual-action reciprocating piston can deliver the fluid by means of suitable valves solely from the reservoir and directly back into this. But it is also possible for a separate pump and additional drive to be used for the coolant.

Similarly possible is a microslip control of the clutch and simultaneous shifting via multiplexing as shown and described in FIG. 1b.

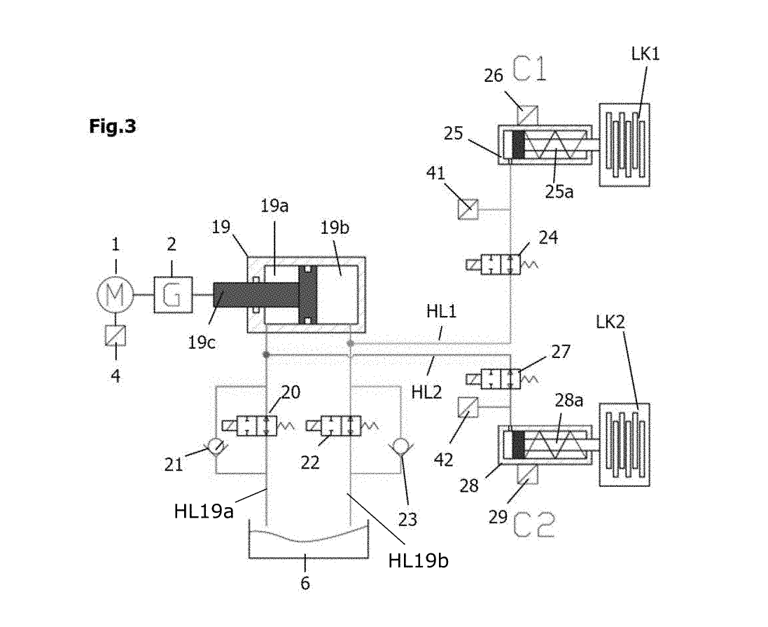

The shift gearbox according to the invention can also be configured with just two clutch selectors, e.g. without a gear selector, as is the case for two-speed gearboxes for E-vehicles with two clutches and shown and described in FIG. 3.

The following advantages can be obtained with the shift gearbox according to the invention:
a) Weight due to a reduction in the number of components.
b) Improved reliability through the introduction of diagnostic processes for leak testing and calibration processes for establishing the change in flow resistances.
c) Reduction in system costs
   Through a reduction in the number of components, in particular by dispensing with the pump, storage, pressure sensor, filter and non-return valves. This is simply replaced by a motor-transmission-piston-unit.
   Through a reduction in the hydraulic fluid required.
   Replacing cost-intensive proportional valves by simple switch valves.
d) Functional improvement
   Use of a position-controlled dual-action reciprocating piston as the pressure supply with pressure reduction via the pressure supply unit for closed systems.
   Optimum utilisation of the torque-speed characteristic of an electric motor for the purpose of a faster operation of one or both clutches.
   Intelligent pressure control procedures with the potential for a reduction in motor size (described in point 2c).
e) Improved reliability
   Diagnostic methods for testing components (valves, tightness of pistons of the gear and clutch selectors and of the pressure supply unit) for leaks via piston control.
   Improvement of the hydraulic system by measuring the hydraulic resistances in the system and detection of changes in operation.
   Measurement methods for checking flow resistances of the hydraulic system and its components (e.g. valves, lines) and determination of shifting forces of the pistons of gear selectors and clutch selectors.
f) Platform concept for automated gear shifting and dual clutches with the fewest possible changes to components in the system.

Advantageous possible embodiments of the shift gearbox according to the invention are explained in more detail below using the drawings.

These show as follows:

FIG. 1a: A shift gearbox with a piston-cylinder unit with dual-action reciprocating piston with eight valves and two dry-running clutch selectors and four gear selectors in the closed hydraulic circuit;

FIG. 1b: Shift gearbox with a piston-cylinder unit with dual-action reciprocating piston with twelve valves and two dry-running clutches and four gear selectors in the closed hydraulic circuit;

FIG. 1c: Shift gearbox with a piston-cylinder unit with dual-action reciprocating piston with intelligent control for clutch operation with potential for downsizing of the motor-transmission-piston-unit by virtue of the use of the stored energy in a clutch;

FIG. 1d: Use of the stored energy in a clutch during the process of switching over between two clutches;

FIG. 1e Performance diagram for a shift gearbox, in which an intelligent pressure control via piston control and exhaust valves takes place to reduce the power consumption;

FIG. 2a: Shift gearbox with a piston-cylinder unit with dual-action reciprocating piston with two wet-running clutches and four gear selectors in the closed hydraulic circuit with additional pump;

FIG. 2b: Shift gearbox with a piston-cylinder unit with dual-action reciprocating piston with two wet-running clutches and four gear selectors in the closed hydraulic circuit with dual-action reciprocating piston (dual-action reciprocating piston-pump) driven by the drive of the piston-cylinder unit;

FIG. 3 Piston-cylinder unit with dual-action reciprocating piston for two-speed system with closed hydraulic circuit;

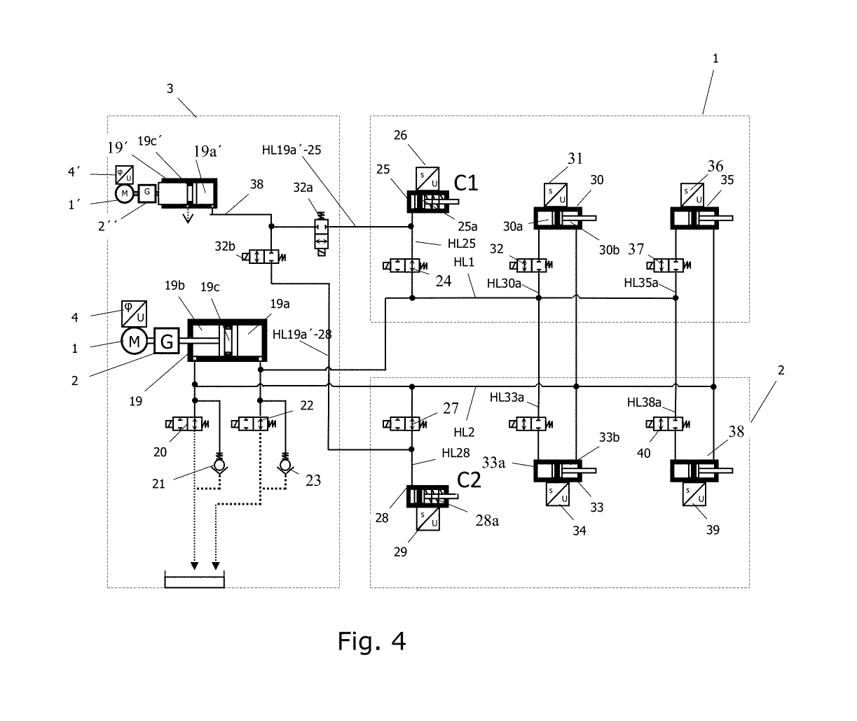

FIG. 4 Expanded shift gearbox with additional piston-cylinder unit.

FIG. 2a shows a first possible embodiment of the shift gearbox according to the invention in the form of a dual-clutch gearbox with a piston-cylinder unit 19 with dual-action reciprocating piston 19c for displacing the hydraulic medium in the clutch selector 25/C1, 28/C2.

The piston-cylinder unit 19 is driven by the drive 1 via the transmission 2. The dual-action reciprocating piston 19c separates the two working chambers 19a and 19b from each other, wherein the piston area 19e, which delimits the working chamber 19b, is larger than the effective piston area 19d, which delimits the working chamber 19a. The working chamber 19a is connected via the main hydraulic line HL2. The working chamber 19b is connected with the main hydraulic line HL1. The hydraulic feed lines HL25, HL28, HL30a, HL30b, HL33a, HL33b, HL35a, HL35b, HL38a and HL38, which connect the main hydraulic lines HL1, HL2 with the clutches 25/C1, 28/C2 and the speed selectors 30, 33, 35 and 38, branch off from the main hydraulic lines HL1, HL2. In each of the hydraulic feed lines HL25, HL28, HL30a, HL30b, HL33a, HL33b, HL35a, HL35b, HL38a and HL38, switchable valves 24, 27, 32, 33, 37, 40 and 41 are arranged for optional shutting off or opening of the feed lines. The two working chambers 19a and 19b are in each case connected via hydraulic lines HL19a and HL19b with a reservoir 6, wherein in the hydraulic lines HL19a and HL19b switchable 2/2-way valves 20, 22 are arranged. In parallel with each 2/2-way valve 20, 22 a non-return valve is arranged.

The shift gearbox according to FIG. 1a with two clutch selectors and four gear selectors requires only eight switchable 2/2-way valves.

The gear selectors 30, each have two working chambers 30a, 30b, 33a, 33b, 35a, 35b and 38a, 38b which create seals and are separated by pistons from each other. With this arrangement it is important that the first working chambers 30a, 33a, 35a, and 38a are connected with the first main hydraulic line HL1 and thus with the working chamber 19b, and that the second working chambers 30b, 33b, 35b, and 38b are connected via the second main hydraulic line HL2 with the working chamber 19a of the piston-cylinder unit 19.

Through this separate arrangement of the connecting lines HL1 and HL2 a gear shift can be implemented as follows: For a gear shift from first to second gear, it is first necessary to select second gear, wherein the clutch C1(25) is depressed into this initial state and thereby also closed. However, so that the volume or the pressure from the clutch C1 does not escape, the clutch selector valve 24 must be closed. To initiate the gear shift, the gear selector valve 1 (35) is opened and the exhaust valve 1 and the clutch selector valve 2 closed. Thereafter, the dual-action reciprocating piston 19c with the motor and transmission units 1 and 2 can be moved to the left, as a result of which volume is displaced into the gear selector 2/4 (33) especially into the chamber 33b. Were the valve 35 not opened during this process, to allow the shifting of the gear selector 33, the system would be hydraulically isolated. Once second gear in the gear selector 2/4 (33) is synchronised in the sub-transmission with, for example, the crankshaft, the gear can finally be selected. Gear selector valve 35 is closed again, clutch selector valve 27 is opened and exhaust valve 20 continues to be closed and clutch operation can be commenced in the clutch C2 (28). To allow shifting without interruptions in traction, a continuous change of load of the two clutches C1 (25) and C2 (28) must take place. The closing of the clutch C2 is undertaken with the help of the pressure build-up in the dual-action reciprocating piston 19, which in turn moves to the left. The simultaneous opening of the clutch C1(25) is achieved by a stepped or also smooth control of the clutch selector valve 24, such that the fluid leaves in a controlled manner via the corresponding exhaust valve 22. Once the load change is complete, the gear selector 1/3 (30) can either be shifted to neutral (mid-position of the shifter fork 30c) or the next gear pre-selected. In doing so, the clutch selector valves 24, 27, and the exhaust valve 22 are closed and the gear selector valve 32 opened. The dual-action reciprocating piston 19 displaces the volume from the chamber 19b and thus moves the gear selector 30 to the right, according to the volume displaced. Selection of first or second gear is finally completed.

Preferably, prior to a journey, the piston 19c is in a mid-position, since it cannot be anticipated if when the vehicle starts first gear or reverse gear will be selected. Thus, corresponding volume for operating a gear selector and a clutch is present for both manoeuvres. Alternatively, when the valves 20 or 22 are open, the piston would have to be moved into the correct position.

During the load change from one sub-transmission to the other sub-transmission, if a clutch 25 is depressed by means of the motor-transmission-piston unit 1, 2 and from the other clutch 28 via the corresponding clutch selector valve 27 fluid is discharged, the clutches can be controlled via possible position sensors 26, 29 or pressure sensors. Depending on the embodiment of the transmission in modern transmissions a pressure or position sensor is used. Dry clutches are generally built with position sensors and wet clutches with pressure sensors. The controlled discharge of the clutches can take place either with the valves 24 and 27 or with the valves 20 and 22 either in a stepped or a smooth manner, depending on the type of valve used. In the embodiment shown simple switch valves (stepped) or a valve with flying similarly-controlled plunger (smooth) are used.

For safety reasons, in each embodiment of the double clutch actuator with eight valves a position sensor 31, 34, 36, 39 is provided in each gear selector 30, 33, 35, 38, so that any leaks in the valves 32, 37, 40, 41 cannot lead to mechanical destruction. The valves 20, 22, 24 and 27 must have a normally open design, so that in the event of a system failure both clutches 25, 28 are immediately opened without requiring further supply.

FIG. 1b shows a design, in which the pressure can be shut off by switch valves 32 and 52, 41 and 53, 37 and 54, 40 and 55 in the gear selectors 30, 33, 35, 38. In the case of a dual-clutch gearbox the clutch C1 or C2 can be operated, which furthermore is operated with what is known as microslip and with which the dual-action reciprocating piston 19 is controlled. Microslip is used in order to attenuate to a certain extent undesired speed fluctuations at the crankshaft and to be able to better estimate the open position of the clutches. The effect of the attenuation is dependent upon the amount of the slip applied to the corresponding clutch. If it is intended to complete a gear shift, then this often lasts for a few hundred milliseconds, since the synchronisation of the unloaded sub-transmission accounts for a majority of the total switching time. With the help of a dual-action reciprocating piston 19 operated by a trapezoidal spindle or a ball screw drive 2, a momentary gear shift can be initiated. Here, the clutch 25 or 28 most recently under load is shut off in the corresponding sub-transmission with the clutch selector-valve 24 or 27 and fluid can now be discharged with valves 24 or 22 and also 27 or 21. In this short time, microslip control is not possible or only to a limited extent, but the clutch nevertheless continues to operate with slip. Then the desired gear selector is operated and moved only as far as the synchronisation point, wherein the pressure in the gear selector can be calculated from the motor current. If the synchronisation is initiated, in the corresponding gear selector the hydraulic pressure can be shut off with switch valves and after a brief time interrupt the dual-action reciprocating piston 19 can restart the microslip control on the loaded clutch 25 or 28. However, to do this the pressure level in the dual-action reciprocating piston 19 must encounter that of the loaded clutch and then open the clutch selector valve 27 or 24 again without pressure differential. Once synchronisation in the unloaded sub-transmission is complete, the final gear shift can be initiated and the load change is completed.

FIG. 1c shows a variant for controlling the two clutches 25/C1 and 28/C2. This is an intelligent modification to allow a reduction in size of the motor 1 for the drive of the hydraulic piston 19, which is driven by means of a spindle 2, and thus save power, weight and space. For example, if it is intended to perform a gear shift from sub-transmission 1 with the clutch C1/25 to sub-transmission 2 with the clutch C2/28, the stored potential energy of clutch C1/25 can be used for the pressure build-up in clutch C2/28. A schematic representation of the process is shown in FIGS. 1d and 1e. FIG. 1d shows possible pressure gradients in the clutches for this modification and FIG. 1e a simplified representation for reduced power consumption of the electric motor 1.

FIG. 1c shows, by means of the arrows, how the fluid flows when there is a load change. Thus, the stored and pressurised fluid in the clutch C1/25 is directed via the lines HL25 and HL1 into the working chamber 19b and exerts a force on the piston 19c towards the left. This force supports the motor 1 when moving the piston 19c to the left to shrink the working chamber 19a in order to build up a pressure in the clutch C2/28. The hatched area shown in FIG. 1d corresponds to the energy which can be saved by the supporting power of the pressurised fluid in the clutch C1/25 when switching the clutch C2/28. If it is intended to open the clutch C2/28 and close the clutch C1/25, then the pressure stored in the clutch C2/28 can similarly be used to support movement of the piston 19c. In this way, the maximum power needed by the motor can be reduced from Pₘₐₓ_{_}_{Th} to Pₘₐₓ, as shown in FIG. 1e. Thus, the motor 1 can have smaller dimensions.

Due to hysteresis and friction losses in the closed hydraulic transmission actuator, during this process there may be too much volume in the system for a proper load change. The exhaust valves 20 and 22 can simultaneously ensure appropriate volume management and discharge any excess fluid via the lines HL19a, HL19b into the reservoir 6. Depending on the design of the motor-transmission-piston-unit 1, 2, 19, in this embodiment when there is a load change between the clutches the maximum output of the motor 1 is required. This means that the motor 1 with overarching intelligent control (motor 1 and valves 20, 22, 24, 27) can generally be built with smaller dimensions. During the start-up phase in particular, until the pressure of the two clutches 25 and 28 are the same, apart from when there are reductions in efficiency (ball screw drive or trapezoidal spindle, hydraulic losses, etc) the motor can generally be dispensed with. Only if the clutch pressure in clutch C2/28 is greater than in clutch C1/25 must the motor, with the support of the residual pressure in clutch C1/25, fully develop the pressure in clutch C2.

FIG. 2a describes the construction of a dual-clutch gearbox with wet-running clutches C1 and C2 and a separate cooling circuit HLP with independent pump 44 with drive motor 43. The functioning and execution of a gear shift are the same as described in FIG. 1a, but the clutches C1 and C2 are controlled via the pressure sensors 41, 42 and not position sensors 26, 29. The position sensors can therefore be dispensed with. Due to high torque transfers and the possible use of multi-plate clutches, the pump 44 is cooled by a separate cooling circuit HLP with its own medium supplied from the tank 46.

FIG. 2b describes a system architecture of a dual-action reciprocating piston with wet-running clutches and separate cooling circuits HLK1 and HLK2 with simultaneously running dual-action reciprocating piston-pump 50 which is connected to the piston provision of the motor-transmission-piston unit 1, 2, 19. With the operation of the independent transmission actuator, by means of a separate dual-action reciprocating piston 50, a pumping function can be undertaken. Thus, an additional pump with motor can be saved. The cooling circuits HLK1, HLK2 operate with separate media as a result of which contamination cannot enter the actual dual-action actuator 19. In this embodiment, the additional dual-action reciprocating piston 50d must be significantly larger than the actual actuator with dual-action reciprocating piston 19c, since several litres per minute of fluid for cooling must be delivered. Since in some circumstances the actuator does not have to perform any gear or clutch selection, coolant can continue to be delivered from the reservoir 47 and via the non-return valves 48 and 49, while valves 20 and 22 are open. The piston 50d can be moved back and forth by means of the drive 1 as a function of the required flow rate—high frequency with intense cooling, low frequency with low cooling—without the clutches C1 and C2 and gear selector being shifted in the process. This is achieved in that the associated valves 24, 27, 32, 37, 40 and 41 are closed and the valves 20 and 22 opened. Optionally, in all the embodiments shown and described in the figures the valve 31 shown in FIG. 1c can be arranged, which in the open state hydraulically connect with each other or short-circuit the two working chambers 19a, 19b. Consequently, cooling can take place in power-on-demand mode. Where the clutch and gear selectors have to be operated, the required flow rate may not be achieved, but this is not critical since the operation is usually over very quickly.

FIG. 3 shows a dual-clutch concept with two gears, which can advantageously be used for electric drives. A modular utilisation of the dual-action reciprocating piston assembly kit is possible, wherein the components for the gear selector are not needed. Thus, a two-gear system without interruptions in traction is possible for electric motor drives. Clutch control is the same as described in FIG. 1a and can take place with pressure sensors 41, 42 or also position sensors 26, 29.

FIG. 4 shows an extension to a system described above. The original system comprises the valve circuits in the sub-transmission 1 and sub-transmission 2 with the respective valves 24, 27, 32, 37, 40 and 41 for operation of the clutches 25, 28 and the gear selector 30, 33, 35, 38. The hydraulic actuator 19, which is driven by the motor 1 via the transmission 2 and has a dual-action reciprocating piston 19c, is connectable with its working chambers 19a, 19b via the two valves 20, 22 with the tank or reservoir 6.

The extension to the shift gearbox consists of the possibility of using the pressure modulator 19, which is driven by the motor 1′ via the transmission 2′, for operating the clutches C1 and C2. To this end, the working chamber 19a′ can be connected via the hydraulic lines HL19a′-25 and HL19a′-28 with the clutch selectors 25, 29, wherein a switch valve 32a, 32b is arranged in each of the hydraulic lines HL19a′-25 and HL19a′-28 for shutting off or opening these. This allows continuous microslip of the respective clutch in traction. Here, the valves 32a, 32b, connecting the pressure modulator 19a′ with the clutch selectors 25, 28, can have a normally open or normally closed design.

The functional features of the switching are explained in more detail in the following.

Situation 1: Microslip Control of Clutch Selector 25 with Simultaneous Gear Shifting in the Sub-Transmission 2.

In the situation described, the pressure modulator 19a′ provides continuous microslip control of the selector 25, while the pressure modulation valve 32b for the clutch selector is open and the pressure modulation valve 32b for the other clutch selector 28 and the clutch valve 24 is closed. Here, the pressure modulator 19a′ controls the microslip of clutch 25 as a function of the clutch travel sensor 26. If now in parallel a gear shift in sub-transmission 2 is necessary, this can be performed by the hydraulic actuator 19. If, by way of example, at the gear selector 33 a switching from the neutral position to the right is necessary, then the valves 20, 22 and 27 are closed and the gear selector admission valve 41 is opened and through a movement of the dual-action reciprocating piston 19c to the right, the dual-action reciprocating piston of the gear selector 33 is shifted to the right and into fourth gear. A movement of the dual-action reciprocating piston to the left similarly offers the possibility of moving the gear selector 33 to the left and thus selecting the corresponding gear. The same applies, of course, to all further gear selectors in sub-transmission 2. There is also a purely theoretical possibility that in parallel with the microslip of clutch 25, via the dual-action reciprocating piston, volume can be shifted to or from the clutch selector 28, and gear selectors 30 and 35.

Situation 2: Deactivation of Clutch a and Simultaneous Activation of Clutch b

Here, the position of clutch a is not controlled via a similarly controlled valve 24 or 30a, but via the pressure modulator 19a′. This allows the valves 24, 27, 30a, 30b to be pure and simple digital switch valves.

On the basis of situation 1 described above, valves 24 and 27 are now open. Valves 30a, 30b, 32, 37, 40 and 41 and pressure modulation valve 32b between clutch selector 28 and the pressure modulator 19a′ are closed where this is not already the case. Via the dual-action reciprocating piston 19c the pressure build-up or the position of the clutch selector 19c are now controlled. The dual-action reciprocating piston 19c also moves to the left. The right-hand chamber of the dual-action reciprocating piston thereby simultaneously draws volume via 24 from the clutch selector 25. In this case, the pressure modulator 19a′ controls the pressure or the position of clutch selector 25. In this situation, the main volume flow is displaced by the dual-action reciprocating piston 19c. The pressure modulator 19a′ only corrects the volume for the clutch selector 28 as required. Once sub-transmission 2 has been activated and sub-transmission 1 deactivated, clutch valves 24 and 27 are closed and the pressure modulator 19a′ is separated by the pressure modulation valve 32a from the clutch selector 25 and connected by the other pressure modulation valve 32b with the clutch selector 28. The pressure modulator 19a′ now controls the microslip on clutch selector 28.

The advantage of this circuit is that the pressure modulator 19a′ has a significantly lower volume management than the dual-action reciprocating piston 19c. The volume flow demands on the pressure modulator 19a′ are also significantly lower than for the volume flow of the dual-action reciprocating piston 19c. Added to this is fact that the system is completely free of analogue valves and works purely with less expensive digitally-switching valves.

For system efficiency diagnosis, this system offers the possibility, by way of example by opening the valves 32b and 27, of connecting the two pressure chambers to each other and thereby balancing the transmission efficiency of pressure modulator 19, 19a′ and hydraulic actuator 19. This balancing can be very helpful both in predicting failures and also matching the pressure settings more accurately and thereby increasing the comfort. The diagnostic option mentioned exists for virtually all systems that have two hydraulic actuators or pressure modulators and offer the possibility of hydraulically connecting the systems quickly.

In emergency mode, in the event of failure of one of the motors 1, 1″ of the pressure modulator 19, 19′ or the hydraulic actuator 19 there is possibility of the respective other pressure supply taking over the gear selection and clutch selection. If in emergency mode, the pressure modulator has to take over the clutch selection and gear selection then so muss by virtue of the lower volume management via the exhaust valves 30a and/or 30b in the meantime volume in the pressure modulator 33 must be called upon. But if the pressure modulator 33 fails, then via the hydraulic actuator 19, apart from brief interruptions in microslip control, function can be maintained. Basically, the extension to the original circuit is only necessary if brief interruptions in microslip control are unacceptable during the gear shifting processes.

### LIST OF REFERENCE SIGNS

1 EC motor
2 Transmission
3 Piston-cylinder unit
4 Rotary sensor for motor commutation
5 Position sensor for clutch selector in automatic transmission
6 Reservoir
7 Clutch unit 1
8 Pressure sensor for clutch selector in automatic transmission
9 2/2-way valve
10 Gear selector unit 1 (rotational movement)
10a, 10b Piston-cylinder units of gear selector 10
11 Gear selector unit 2 (linear movement)
12 Piston of gear selector mechanism 1, rotation (3 positions)
13 Gear selector mechanism 2, translation (3 positions)
14 2/2-way valve
15 Return spring of the gear selector mechanism 2
16 2/2-way valve
17 Rotation body of gear selector-mechanism (3 positions)
18 2/2-way valve
19 Dual-action reciprocating piston
19a Hydraulic chamber of the dual-action reciprocating piston for hydraulic circuit HL2
19b Hydraulic chamber of the dual-action reciprocating pistons for hydraulic circuit HL1
19b Hydraulic operation piston
20 2/2-way admission and exhaust valve for HL2
21 Non-return valve for HL2
22 2/2-way admission and exhaust valve for HL1
23 Non-return valve for HL1
24 2/2-way admission and exhaust valve for clutch C1
25 Clutch selector C1
25a Hydraulic piston of clutch selector C1
26 Position sensor for clutch selector C1
27 2/2-way admission and exhaust valve for clutch C2
28 Clutch selector C228a Hydraulic piston of clutch selector C2
29 Position sensor for clutch selector C230 Gear selector 1/3
30a Hydraulic chamber 1 of gear selector 1/3
30b Hydraulic chamber 2 of gear selector 1/3
30c Piston with shifter fork of gear selector 1/3
31 Position sensor of gear selector 1/3
32 2/2-way admission and exhaust valve 1 for gear selector 1/3
33 Gear selector 2/4
33a Hydraulic chamber 1 of gear selector 2/4
33b Hydraulic chamber 2 of gear selector 2/4
33c Piston with shifter fork of gear selector 2/4
34 Position sensor of gear selector 2/4
35 Gear selector 5/7
35a Hydraulic chamber 1 of gear selector 5/7
35b Hydraulic chamber 2 of gear selector 5/7
35c Piston with shifter fork of gear selector 5/7
26 Position sensor of gear selector 5/7
37 2/2-way admission and exhaust valve 1 for gear selector 5/7
38 Gear selector 6/R
38a Hydraulic chamber 1 of gear selector 6/R
38b Hydraulic chamber 2 of gear selector 6/R
38c Piston with shifter fork of gear selector 6/R
39 Position sensor of gear selector 6/R
40 2/2-way admission and exhaust valve 1 for gear selector 6/R
41 2/2-way admission and exhaust valve 1 for gear selector 2/4
42 Pressure sensor for clutch selector 2
43 Pressure sensor for clutch selector 1
44 Pump of cooling circuit HLP
45 Non-return valve of cooling circuit HLP
46 Reservoir of cooling circuit HLP
47 Motor for pump of cooling circuit HLP
48 Non-return valve of dual-action reciprocating piston-pump hydraulic chamber 1
49 Non-return valve of dual-action reciprocating piston-pump hydraulic chamber 2
50 Dual-action reciprocating piston-pump hydraulics
51 Reservoir of dual-action reciprocating piston-pump hydraulics
52 2/2-way admission and exhaust valve 2 for gear selector 1/3
53 2/2-way admission and exhaust valve 2 for gear selector 2/4
54 2/2-way admission and exhaust valve 2 for gear selector 5/7
55 2/2-way admission and exhaust valve 2 for gear selector 6/R
HL Hydraulic line of an automatic transmission
HL_{R} Recirculation and lag of the hydraulics of an automatic transmission
HL1 Hydraulic line 1 of a dual-action reciprocating piston
HL2 Hydraulic line 2 of a dual-action reciprocating piston
HLP Hydraulic line of a cooling circuit with pump
HLK1 Hydraulic line 1 of a cooling circuit with dual-action reciprocating piston pump
HLK2 Hydraulic line 2 of a cooling circuit with dual-action reciprocating piston pump
LK1 Multi-plate clutch 1
LK2 Multi-plate clutch 2

1. A shift gearbox, comprising:
a control unit;
at least one electric motor drive;
multiple shift gearbox units, including at least two clutch units; and
at least one piston-cylinder unit, driven by a respective one of the electric motor drives, and which has a piston and is connected via hydraulic lines to the multiple shift gearbox units, and which is configured to shift the multiple shift gearbox units, wherein the piston of the piston-cylinder unit is in the form of a dual-action reciprocating piston, wherein the dual-action reciprocating piston sealingly separates two working chambers of the dual-action reciprocating piston from each other, wherein each working chamber is connected via a respective main hydraulic line to one respective clutch, and at least one of the two working chambers of the dual-action reciprocating piston or at least one main hydraulic line is enabled to be connected to a reservoir hydraulically via a switch valve.

2. The shift gearbox according to claim 1, wherein at least one of the working chambers of the at least one piston-cylinder unit is hydraulically connected via a hydraulic line with at least one gear selector, wherein the hydraulic connection thusly established between the at least one of the working chambers and the at least one gear selector is enabled to be optionally shut off by means of a valve associated with the at least one gear selector.

3. The shift gearbox according to claim 1, further comprising at least two main hydraulic lines that are enabled to be hydraulically connected to each other via a switch valve, wherein the at least two main hydraulic lines are connected to hydraulic feed lines to the two working chambers of the piston-cylinder unit.

4. The shift gearbox according to claim 3, wherein pressure stored in a shift gearbox unit a clutch is used to support driving of the piston of the piston-cylinder unit, wherein the pressure from the respective shift gearbox unit is fed via an open valve in a respective one of the hydraulic feed lines and an associated main hydraulic line into one of the working chambers of the piston-cylinder unit, wherein the piston is driven by means of the electric motor drive for shrinking the other working chamber of the piston-cylinder unit, whereby hydraulic volume is displaced into another main hydraulic line or pressure is built up in the another main hydraulic line.

5. The shift gearbox according to claim 1, wherein the piston has two different-sized piston active surface areas, in a ratio of between 1.5:1 and 2.5:1, which delimit the two working chambers.

6. The shift gearbox according claim 5, wherein the different surface areas of the piston are utilised to reduce torque, with slip control of one of the clutches, wherein a valve associated with the respective one of the clutches is open during pressure build-up and/or pressure reduction in the respective clutch.

7. The shift gearbox according to claim 1, wherein the dual-action reciprocating piston has two differently-sized hydraulically active piston surface areas, and a faster pressure build-up or volume delivery takes place via the working chamber delimited by the larger piston active surface area.

8. The shift gearbox according to claim 1, further comprising a switch valve, through which, in its open position, the two working chambers are hydraulically connected to each other.

9. The shift gearbox according to claim 1, wherein a pressure reduction takes place via one working chamber of the piston-cylinder unit and simultaneously a pressure build-up takes place via the other working chamber of the piston-cylinder unit, or a volume of the working chamber is delivered via valves to the reservoir and thus only pressure reduction takes place.

10. The shift gearbox according to claim 1, wherein the control unit is configured to control the electric motor drive for shifting at least one of the shift gearbox units, wherein a control variable for controlling the drive is a rotation angle of the drive, a motor current flowing through the drive, a position of the piston and/or a travel of the piston, wherein the piston thereby delivers a required hydraulic volume to or from the at least one of the shift gearbox units.

11. The shift gearbox according to claim 1, wherein pressure reduction in a shift gearbox unit takes place by opening a valve associated with the respective shift gearbox unit and the switch valve that connects the main hydraulic line coupled to the respective shift gearbox unit with the reservoir.

12. The shift gearbox according to claim 11, wherein pressure regulation during pressure build-up and/or reduction in a shift gearbox unit takes place using a signal from a sensor associated with the respective shift gearbox unit.

13. The shift gearbox according to claim 1, wherein at least one clutch is cooled by means of a coolant, wherein the coolant is delivered by means of the electric motor drive or a separate drive configured to drive a pump.

14. The shift gearbox according to claim 1, further comprising a further piston, which sealingly separates two further working chambers from each other, wherein the further working chambers are connected via hydraulic lines with wet clutches for their cooling, wherein fluid pumped from the further working chambers reaches a further reservoir via the wet clutches and is drawn from the further reservoir into the further working chambers via suction lines and non-return valves.

15. The shift gearbox according to claim 14, wherein the electric motor drive is configured to drive the further piston, wherein the piston is rigidly connected with the further piston, via a piston rod.

16. The shift gearbox according to claim 2, wherein for shifting a gear selector, a predetermined quantity of hydraulic medium is delivered via the valve associated with the gear selector to a respective first working chamber of the gear selector from a working chamber of the dual-action reciprocating piston and simultaneously hydraulic medium is taken from the other working chamber of the dual-action reciprocating piston and/or discharged via one of the switch valves into the reservoir.

17. The shift gearbox according to claim 1, wherein control for the electric motor drive uses at least one map, in the form of a pressure-volume characteristic.

18. The shift gearbox according to claim 17, wherein the control uses a model for pressure calculation, wherein the model for determining a control variable for the electric motor drive for a pressure to be controlled in a clutch unit takes account of at least a motor current, and a clutch spring stiffness.

19. The shift gearbox according to claim 1, wherein the shift gearbox further includes at least one pressure sensor for control compensation or for pressure control of clutch pressure.

20. The shift gearbox according to claim 1, wherein at least one hydraulic feed line branches from or extends a hydraulic line that connects a main hydraulic line with one first working chamber of a shift gearbox unit, wherein, for optional shutting off of the hydraulic feed line, a switchable valve is arranged therein.

21. The shift gearbox according to claim 1, wherein a first working chamber of a shift gearbox unit is connected via a hydraulic feed line with a main hydraulic line, wherein a second working chamber of the respective shift gearbox unit is connected via a further hydraulic feed line with another main hydraulic line, wherein in one of or in both the feed lines a switchable valve is arranged for optional opening and shutting off of the feed line.

22. The shift gearbox according to claim 1, wherein one more of the at least one shift gearbox units has or have a position sensor or positioning sensor.

23. The shift gearbox according to claim 22, wherein signals from the position sensor or positioning sensor are used for controlling the electric motor drive and/or for calibrating a control and a simulation model.

24. The shift gearbox according to claim 22, wherein pressure reduction in a shift gearbox unit takes place via the hydraulic feed line and the main hydraulic line coupled to the respective shift gearbox unit, wherein a switching valve arranged in the hydraulic feed line is controlled through evaluation of a signal from the position or positioning sensor for pressure reduction, wherein the switching valve is opened for a predetermined time or by means of pulse-width modulation (PWM).

25. The shift gearbox according to claim 22, wherein the position or positioning sensor has a discrete configuration, which is used in control solely for checking positions of a gear or clutch selector or for leak diagnosis.

26. The shift gearbox according to claim 1, wherein at least two shift gearbox units are simultaneously shifted in multiplex mode, wherein shifting of each of the at least two shift gearbox units takes place in small partial steps, carried out alternately for each shift gearbox unit.

27. The shift gearbox claim 1, wherein the shift gearbox has only two clutch selectors, without a gear selector.
